(19) United States
(12) Patent Application Publication
(10) Pub. No.: US 2026/0266382 A1
(43) Pub. Date: Sep. 10, 2026

(54) TANGENTIAL PURGE OF BALL VALVE

(71) Applicant: FloWorks International LLC, Houston, TX (US)

(72) Inventor: Jason WALKER, Houston, TX (US)

(73) Assignee: FloWorks International LLC, Houston, TX (US)

(21) Appl. No.: 19/553,663

(22) Filed: Mar. 2, 2026

Related U.S. Application Data
(60) Provisional application No. 63/766,956, filed on Mar. 4, 2025.
(60) Provisional application No. 63/949,875, filed on Dec. 29, 2025.

(51) Int. Cl. F16K 5/06; C10B 27/06

(52) U.S. Cl. CPC F16K 5/0605; C10B 27/06

(57) ABSTRACT

A ball valve having tangential purge configuration is described, wherein the tangential flow is such as to drive purge fluid all the way around the ball, thereby increasing lifespan of the ball valve. To achieve tangential flow around the ball, the inlet purges and channels through the seat are oriented at a tangent to the ball.

This application claims priority to U.S. Ser. No. 63/949,875, filed Dec. 29, 2024 and to 63/766,956, filed Mar. 4, 2025, each incorporated by reference in its entirety for all purposes.

### FIELD OF THE DISCLOSURE

The disclosure generally relates to a ball valve configuration wherein the purge inlets are configured so as to inject the purge fluid tangentially to the ball. This provides superior purging and lengthens valve life, especially in the extremely harsh environment of a delayed coker unit.

### BACKGROUND OF THE DISCLOSURE

Petroleum refining operations where crude oil is processed frequently produce residual oils that have very little value, but value can be increased when processed in a delayed coker unit (“DCU”). The delayed coker heats residual oil in a furnace to a temperature sufficient to cause destructive distillation, wherein a substantial portion of the residual oil is converted, or “cracked” to usable hydrocarbon products and the remainder yields a residual petroleum by-product called “coke,” a material composed mostly of carbon that has significant industrial uses.

The delayed coker process is a batch process (see FIG. 1) using drums in pairs so that one can make coke while the other is being decoked. The name “delayed” arises because the cracking process continues as the material resides in the coke drums. It is one of the most hostile environments in the refinery due to the abrasive and erosive properties of the coke by-product.

The coking batch process requires frequent use of switch valves during the coke drum switching operation. It is important for the coke drum to be stripped, cooled and decoked. These valves allow personnel to safely unhead a cooled drum while another drum is ‘live’. If the valves do not positively isolate the live coker drum, product could leak into the off-line drum creating a safety hazard for personnel. The valves isolating the feed heaters are also critical to operation when it becomes necessary to de-coke a heater. If the valves do not isolate, the unit will be shutdown.

Although coking valves are designed to handle the harsh conditions in the refinery, coke buildup inside the coker valves is inevitable, and any buildup reduces internal tolerances and negatively impacts operations. Coker valves are thus cycled (replaced) frequently as failure can lead to complete shutdown, resulting in large down time and significant financial impact. Optimizing valve life-cycle is thus critical to operational efficiency.

Coke buildup is addressed with purge valves. Purging is the process of removing material from valves by injecting steam or other available fluid to flush the valve. Purging ports are configured on the large complex coking valves where ever buildup is deemed likely. Typically steam is injected into the purging ports at high pressure, although atmospheric gas oil (AGO) and vacuum gas oil (VGO) may be used instead. The purge fluid is injected at much higher than the operating pressure of the delayed coking process, that pressure keeping process fluid from entering valve spaces and/or sweeping any process fluid out of these spaces.

Conventionally, all purge ports that are attached to multiple coking valves are connected to the same steam source, and the steam is continuously supplied to prevent buildup. In this setting, large amounts of steam are consumed in the purging process, which contributes to the operational costs. Furthermore, the amount of steam is constant, and not capable of fine control to meet varying operational needs at individual purge ports.

In addition, the purge valves are mounted perpendicularly to the body and/or the ball for ease of installation. However, perpendicular mounting results in poor diffusion of purge fluid around the ball in a ball valve, leaving dead spots that are more susceptible to coke deposition.

Therefore, there is a need for improved and precise purging that removes process build up, especially in the coker context. This invention meets one or more of these needs.

### SUMMARY OF THE INVENTION

This disclosure provides a new purge inlet design suitable for any ball valve, which is intended to provide tangential purging forces around the ball. The purge connections are installed at a tangent to the internal ball surface, so as to produce tangential flushing of process build up in valve cavities. If a plurality of tangential purge valves are installed consistently with the desired flow path, the injection forces will create a vortex in the valve body between the seat and ball when operating, resulting in high performance purging of this zone.

In more detail, instead of being mounted perpendicularly to the ball surface, the purge inlets are mounted at a tangent to the surface of the ball. If two opposing inlets are provided on each side of the ball, a sweeping motion around the ball will be provided, thereby clearing the entire space between the ball and the seat.

Currently, purge inlets for coker valves of the ball type are mounted perpendicularly to the ball for ease of manufacture. See FIG. 2. However, with this design, there can be dead spots that are not sufficiently cleared of process fluid, thus quickly ruining the valve and necessitating rebuild or replacement.

This is conformed by the modelling shown in FIG. 3. In FIG. 3 we see heat flow with a traditional closed perpendicular entry inlet (A), and opened in (B). As can be seen, the heat (and thus the fluid) is not well distributed in (B), but is concentrated near the open inlets. By contrast in (C) with an open tangential inlet, fluid is driven cirularly around the pipe and travels the length of the pipe.

Encouraged by the modelling results, we built and tested a pair of tangential purge inlets mounted on a coker valve so that steam enters tangentially. The inlets were opposite one another and oriented in opposite directions, causing the purge fluid to move completely around the ball, effectively protecting the annular cavity between the ball and seat from coke deposition. See FIG. 4. The typical lifespan of the coker valve tested was only three months, but with tangential purging, the lifespan increased at least ten-fold. Although our prototyping tests only included two purge inlets, more can be placed, so long as they are mounted consistently with the desired direction of fluid motion.

The invention includes any one or more of the following embodiment(s) in any combination(s) thereof.
A ball valve, said ball valve comprising: i) a body housing a seat and a ball with a flow channel through said ball; ii) a space between said seat and said ball; iii) at least two purge inlets penetrating through said body and said seat and fluidically connected to said space; iv) said at least two purge inlets configured for attachment to a source of purge fluid; v) said at least two purge inlets mounted at a tangent to said ball so as to inject purge fluid into said space at a tangent to said ball; and vi) said at least two purge inlets oriented to drive said purge fluid around said space and said ball.

Any ball valve herein described, wherein said ball valve is a coker ball valve.

Any ball valve herein described, wherein said at least two purge inlets are mounted on opposite sides of said ball in opposite orientations.

Any ball valve herein described, wherein said ball in said ball valve is mounted on a trunnion.

Any ball valve herein described, wherein said ball valve is a coker ball valve and wherein said ball in said ball valve is mounted on a trunnion.

Any ball valve herein described, wherein said ball valve is a coker ball valve, and said coker ball valve is a switch ball valve for switching flow from a first coke drum to a second coke drum. Alternatively, said coker ball valve is an isolation ball valve.

Any ball valve herein described, said ball valve comprising a pair of seats bracketing said ball, a space between each seat in said pair of seats and said ball.

Any ball valve herein described, each seat in said pair of seats having at least two purge inlets mounted at a tangent to said ball so as to inject purge fluid into each said space at a tangent to said ball.
A system for delayed coking, said system comprising a furnace in fluidic connection to a first coke drum and to a second coke drum, and any one or more ball valve(s) herein described for controlling flow from said furnace and said first and second coke drums.
A system for chemical processing, comprising pipes or drums in fluidic connection with any one or more ball valves herein described.

Note that although we have described the ball valve with tangential purging in the context of a delayed coker unit, purge valves are used with ball valves in many arts, including chemical plants other than refineries, heavy engines, water treatment plants, and the like.

Furthermore, although we have described steam use, as is common in DCU units, the purge fluid can be any suitable fluid including steam, AGO, VGO and the like.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

The following abbreviations are used herein:

| ABBREVIATION | TERM |
|---|---|
| AGO | Atmospheric Gas Oil |
| VGO | Vacuum Gas Oil |
| DCU | Delayed coker unit |

### BRIEF DESCRIPTION OF THE DRAWINGS

FIG. 1. Prior art: Delayed coking system.

FIG. 2 Prior art: Cross section of perpendicular injection of purge fluid into a ball valve.

FIG. 3 Modelling of standard perpendicular purge inlets closed in (A) and open in (B). Tangential purging is shown in (C).

FIG. 4. Simplified cross section of ball valve with tangential purge inlets.

FIG. 5. Cross section of ball valve with tangential purge inlets.

### DETAILED DESCRIPTION

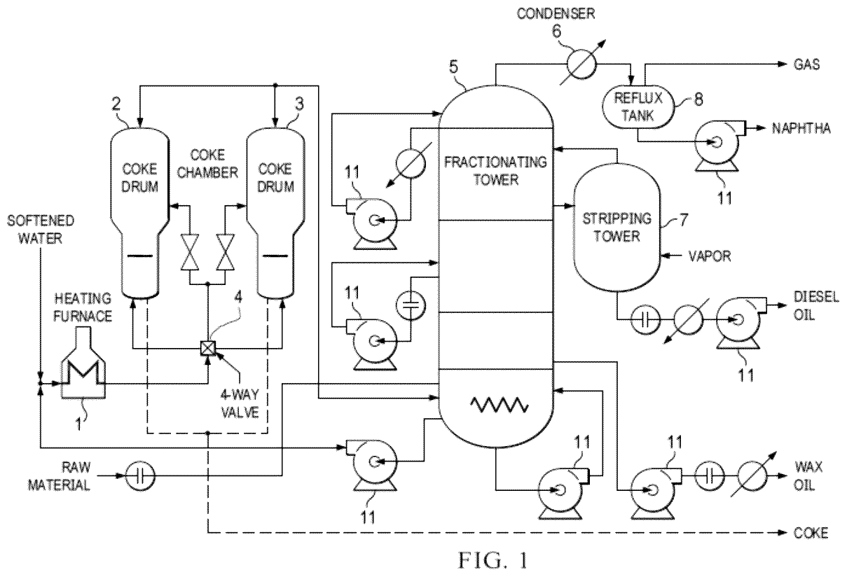

FIG. 1 depicts a simplified schematic of a delayed coker unit with furnace 1, coke drums 2 and 3, and 4-way switch valve 4. Feed enters the furnace from the left, along with water to delay the coking, and from there enters drum 2 or drum 3, depending on switch valve 4. The process fluid continues the coking process in these drums 2, 3, and is eventually removed and sold. Lighter material travels to the fractionater 5, condenser 6, stripper 7, refluxer 8 to produce products such as gas, naptha, deisel, and wax-which are separately collected. Several pumps 11 move process fluids around and most of the valves are omitted herein for simplicity.

While first coke drum 2 is online and being filled, second coke drum 3 is going through a decoking process to purge the manufactured coke contained therein. Thereafter, when first coke drum 2 has reached capacity, the drum inlet is switched via switch valve 4 (often a 4-way ball valve) to second coke drum 3 that has previously been purged of its contents. Then first coke drum 2 is cooled for the decoking process where its contents will be purged, typically with hydraulic jets, and the coke collected for sale. This cyclical process, commonly referred to as batch-continuous, allows the refinery to maintain continuous uninterrupted operation.

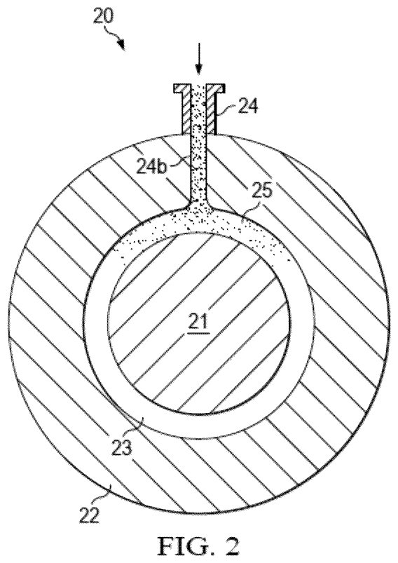

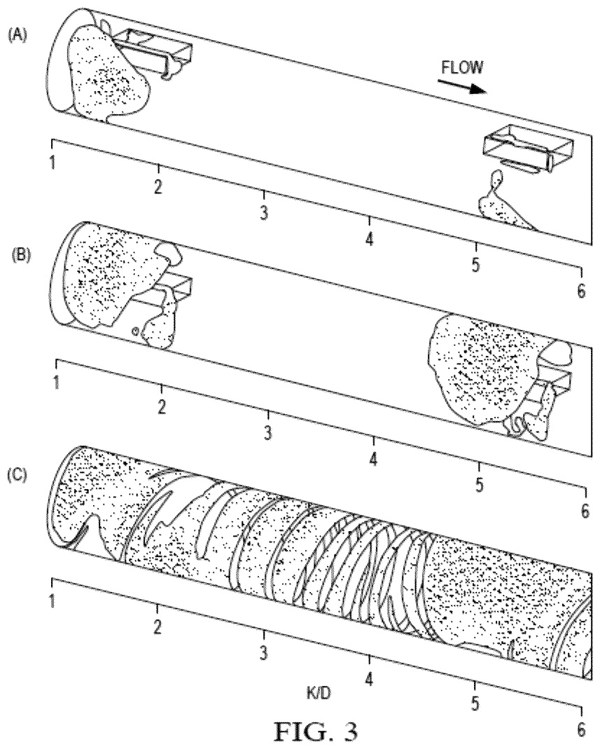

FIG. 2 shows a cross section of a simplified ball valve 20 with ball 21, seat 22 and a greatly exaggerated space 23 therebetween. The housing is omitted herein for simplicity. The inlet valve 24 (and seat channel 24b) is mounted so as to inject purge fluid 25 perpendicular to the ball surface, and the distribution of purge fluid is thus poor. This is confirmed in the modelling shown in FIG. 3—modelling of standard perpendicular purge inlets open in (B).

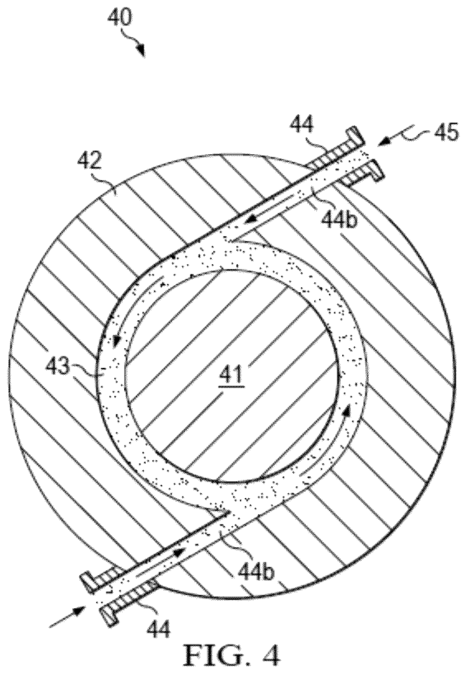

FIG. 4 shows a cross section of a simplified ball valve 40 with ball 41, seat 42 and a greatly exaggerated space 43 therebetween. Again the housing and many details are omitted for simplicity. Here the inlet valves 44 are mounted so as to inject purge fluid 45 perpendicular to the ball surface, and the seat is machined to continue the inlet flow path (see channels 44b). With tangential injection, the purge fluid is evenly distributed around the ball, travelling in the direction indicated by the arrows. This is confirmed in the modelling shown in FIG. 3—tangential purging in (C).

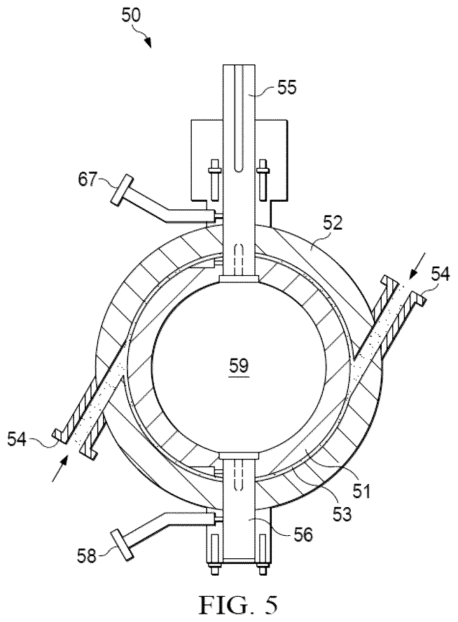

FIG. 5 provides a more detailed diagram of the inventive ball valve 50 with ball 51 have tunnel or hole 59, seat 52, and small space 53 therebetween. Two tangent purge inlets 54 (herein mounted on the sides, but position and number may vary) are also seen. These are not connected, but when in use will be fluidly coupled to a source of purge fluid, typically steam, VGO or AGO. The stem is 55 and trunnion 56 and these are also equipped with a stem purge inlet 67 and trunnion purge inlet 58.

The benefit of the tangential purge inlets on the ball of the ball valve means that the cavity between the seat and the ball will be better swept, and thus the seat and ball will have a longer lifespan. In our tests to date lifespan of these components was increased ten-fold.

The following references are incorporated by reference in their entirety for all purposes.
U.S. Pat. No. 11,118,695 Multiport valve
U.S. Pat. No. 8,282,074 Delayed coker isolation valve systems
U.S. Pat. No. 8,459,608 Seat and valve systems for use in delayed coker system
U.S. Pat. No. 11,174,963 Coker switch valve operating system and method

1. A ball valve, said ball valve comprising:
i) a body housing a seat and a ball with a flow channel through said ball,
ii) a space between said seat and said ball;
iii) at least two purge inlets penetrating through said body and said seat and fluidically connected to said space;
iv) said at least two purge inlets configured for attachment to a source of purge fluid;
v) said at least two purge inlets mounted at a tangent to said ball so as to inject purge fluid into said space at a tangent to said ball; and
vi) said at least two purge inlets oriented to drive said purge fluid around said space and said ball.

2. The ball valve of claim 1, wherein said ball valve is a coker ball valve.

3. The ball valve of claim 1, wherein said at least two purge inlets are mounted on opposite sides of said ball in opposite orientations.

4. The ball valve of claim 1, wherein said ball in said ball valve is mounted on a trunnion.

5. The ball valve of claim 1, wherein said ball valve is a coker ball valve and wherein said ball in said ball valve is mounted on a trunnion.

6. The ball valve of claim 5, wherein said at least two purge inlets are mounted on opposite sides of said ball in opposite orientations.

7. The ball valve of claim 2, wherein said coker ball valve is a switch ball valve for switching flow from a first coke drum to a second coke drum.

8. The ball valve of claim 2, wherein said coker ball valve is an isolation ball valve.

9. The ball valve of claim 5, wherein said coker ball valve is a switch ball valve or an isolation ball valve.

10. The ball valve of claim 1, said ball valve comprising a pair of seats bracketing said ball, a a space between each seat in said pair of seats and said ball.

11. The ball valve of claim 10, each seat in said pair of seats having at least two purge inlets mounted at a tangent to said ball so as to inject purge fluid into each said space at a tangent to said ball.

12. A system for delayed coking, said system comprising a furnace in fluidic connection to a first coke drum and to a second coke drum, and one or more ball valve(s) of claim 1 for controlling flow from said furnace and said first and second coke drums.

13. A system for delayed coking, said system comprising a furnace in fluidic connection to a first coke drum and to a second coke drum, and one or more ball valve(s) of claim 3 for controlling flow from said furnace and said first and second coke drums.

14. A system for delayed coking, said system comprising a furnace in fluidic connection to a first coke drum and to a second coke drum, and one or more ball valve(s) of claim 5 for controlling flow from said furnace and said first and second coke drums.

15. A system for delayed coking, said system comprising a furnace in fluidic connection to a first coke drum and to a second coke drum, and one or more ball valve(s) of claim 6 for controlling flow from said furnace and said first and second coke drums.

16. A system for delayed coking, said system comprising a furnace in fluidic connection to a first coke drum and to a second coke drum, and one or more ball valve(s) of claim 7 for controlling flow from said furnace and said first and second coke drums.

17. A system for delayed coking, said system comprising a furnace in fluidic connection to a first coke drum and to a second coke drum, and one or more ball valve(s) of claim 10 for controlling flow from said furnace and said first and second coke drums.

18. A system for delayed coking, said system comprising a furnace in fluidic connection to a first coke drum and to a second coke drum, and one or more ball valve(s) of claim 11 for controlling flow from said furnace and said first and second coke drums.

19. A system for chemical processing, comprising pipes or drums in fluidic connection with one or more ball valves of claim 1.

20. A system for chemical processing, comparison pipes or drums in fluidic connection with one or more ball valves of claim 3.
